(19) United States
(12) Patent Application Publication
(10) Pub. No.: US 2006/0126833 A1
(43) Pub. Date: Jun. 15, 2006

(54) Protection of electronic data

(75) Inventors: Paul O'Leary, Tramore (IE); Kieran Murphy, Waterford City (IE); Michael McCarthy, Waterford (IE)

Correspondence Address: JAMES D. HALL;BOTKIN & HALL, LLP, 105 E. JEFFERSON BLVD., SUITE 400, SOUTH BEND, IN, 46601, US

(73) Assignee: Pendula Limited

(21) Appl. No.: 11/284,256

(22) Filed: Nov. 21, 2005

(30) Foreign Application Priority Data
Nov. 22, 2004 (IE) S2004/0777

(51) Int. Cl. H04L 9/00

(52) U.S. Cl. 380/30

(57) ABSTRACT

There is disclosed a scheme for secure distribution of content in a manner that users will perceive as fair, while enforcing restrictions on the use of the content in accordance with the intentions of the content originator. The scheme provides a method of encrypting data set comprising: generating a seed value; seeding a pseudo-random number generator with the seed value; creating an encrypted data set by combination of the output of the pseudo-random number generator with the data set; and encrypting the seed value and associating the encrypted seed value with the encrypted data set. In a typical embodiment, the encrypted seed and the encrypted data are combined in a single file and conveyed to a media player that includes decryption core compatible with the encoding encryption scheme. Also disclosed is a content distribution system and a media player to take advantage of such an encryption scheme and a media player for use with the scheme. Content is decrypted on the fly using encryption data that is specific to a media player for which it is inteded to be used.

This invention relates to the protection of electronic data. It has particular, but not exclusive, application to protection of proprietary content in machine-readable form.

It is well-recognised that there is a demand for content such as music, video and so forth, to be distributed over the Internet. However, this has proven to be problematic. From the point of view of the content provider, there must be some safeguard in place to prevent users copying and distributing content that they have acquired with disregard to copyright subsisting in the content. From the user's point of view, any such security arrangements must allow the content to be used fairly. Most especially, a user should be able to make backup copies of any content to protect against loss through failure of storage media or, particularly where the content is for use on a portable media player, through loss of or damage to the player.

There have been many schemes proposed whereby data can be protected by encryption, with some limitation being placed upon the circumstances under which decryption can be undertaken. In such schemes, there is normally a trade-off between the security of the encryption algorithm used and the computational effort required to decrypt the data. In the case of audio or video content, it is necessary that the decryption be carried out in real time as the media is played to avoid the need to store the content in unencrypted form. (Of course, the alternative is to decrypt the data once and store it in unencrypted form, but this represents a significant security risk.) Especially in the case of video content, the required data throughput can be difficult to achieve in compact, portable devices with limited processing capacity.

An aim of this invention is to provide a scheme for secure distribution of content in a manner that users will perceive as fair, while enforcing restrictions on the use of the content in accordance with the intentions of the content originator. It is a further aim of the invention that the process of decryption of the content should be computationally easy so that it can take place in real-time on a portable media player. A further aim of the invention is to provide a content distribution system and a media player to take advantage of such a scheme.

From one aspect, this invention provides a method of encrypting data set comprising:

generating a seed value;

seeding a pseudo-random number generator with the seed value;

creating an encrypted data set by combination of the output of the pseudo-random number generator with the data set; and

encrypting the seed value and associating the encrypted seed value with the encrypted data set.

The encryption of the seed value can be carried out using encryption techniques of high complexity. Since it need be decrypted only once to initiate the decryption of the data set using the seed value, the corresponding decryption algorithm does not need to be performed in real time in, for example, reproduction of encrypted audio or video content. During decryption of the data set, only the pseudo-random number generator and the reverse of the combination operation must be performed in real time.

For example, the combination operation may be an exclusive-OR operation. This has the advantage that it is its own inverse, i.e. A xor B xor B=A so the same pseudo-random number generator can perform both encryption and decryption. It is also an operation that can be performed very quickly in hardware.

The step of encrypting the seed value may include application of a Rivest, Shamir, Adleman (RSA) encryption algorithm. Such an algorithm can be made to be very secure provided that appropriate parameters are chosen for its implementation. However, an implementation of an RSA algorithm that offers a high level of security typically also requires substantial processing power. Therefore, in embodiments of the invention, a comparatively weak implementation of the RSA algorithm is strengthened by applying a transform to the encrypted seed. This adds another layer of obfuscation of the key through which an intruder must penetrate. For example, the transform may be implemented by passing the data through a linear feedback shift register (LFSR) or by processing the data with software that emulates a LFSR, preferably one that is configured to generate a maximal length sequence, to afford a high level of security. The configuration of taps on the LFSR, or the factors of its generator polynomial, effectively becomes part of the encryption key, and a reverse transform must be applied to the encrypted seed as part of a corresponding description process. To further augment the obfuscation, the LFSR register may be made to undergo a pseudo-random number of iterations after the seed value has been set. This number of iterations may vary from one player device to another, and would therefore effectively be another part of the encryption/decryption key.

The encryption key used for the RSA encryption algorithm and/or the configuration of taps on the LFSR may be retrieved from a database of keys, the particular key used being one that is associated with a user for whom or a device for which will make use of the encrypted data.

Clearly, it is central to the security of the encryption method that the output sequence of the pseudo-random number generator cannot be predicated by inspection of the encrypted data. It is of importance that as little information as possible is included in the encrypted stream that could be used as a basis for deducing the output of the pseudo-random number generator. One way in which this can be achieved is to maximise repeat period of the stream produced by the pseudo-random number generator. Preferably, the repeat period is more than half the length of the data set to be encrypted (that is, fewer than two cycles are required to encrypt the entire data set). Most preferably, the period of the pseudo-random number generator is greater than the length of the data set to be encrypted such that less than a complete cycle is required to encrypt the entire data set.

In advantageous embodiments, the pseudo-random number generator is implemented as or is arranged to emulate the output of a non-linear feedback shift register NLFSR. A NLFSR is typically used in a corresponding decryption algorithm that is implemented in hardware. However, for encryption, where there is often no requirement for real-time operation, the pseudo-random number generator may be implemented in software to emulate an actual NLFSR.

In a typical implementation, the encrypted data set is stored in a file together with the encrypted seed value. Most preferably, the encrypted seed value is stored at the start of the file, such that the seed can be received before the encrypted data in cases where the data is being delivered in a stream.

From another aspect, this invention provides a method for decrypting a data set comprising
receiving an encrypted seed value associated with the data set;
decrypting the seed value and seeding a pseudo-random number generator with the seed value;
creating an unencrypted data set by combination of the output of the pseudo-random number generator with the encrypted data set.

This method is typically applied to a file that contains both encrypted content and the seed value in encrypted form. Most typically, it operates on a data set that has been encrypted by a method that embodies the first aspect of the invention.

From a third aspect, this invention provides a method of secure distribution of a data set from a server to a client in which the data set is encrypted by way of a method embodying the first aspect of the invention, transmitting the data over a network link, and decrypting the data by a method embodying the second aspect of the invention.

From another aspect, this invention provides a method for distributing content from a content server for use by a pre-registered user, comprising: receiving a request from a user for an item of content; identifying the user; obtaining from a database encryption data corresponding to the identified user; encrypting the content using the encryption data; and transmitting the encrypted content to the user; in which the encryption data is associated with the user upon registration and is not subsequently communicated to the user.

This aspect of the invention may make use of methods of encryption and decryption embodying, respectively, the first and second aspect of the invention.

The encryption data may include a specification of the taps to be set on the LFSR during application of the transform. It may also include an RSA encryption key.

A method embodying this aspect of the invention may include a step of embedding in encrypted content a value that identifies the device by which it is intended to be reproduced. In such cases, the method may further comprise comparing the value that identifies the device within the data set with a value that identifies the device into which the data has been loaded and causing operation of the device to be discontinued in the event that the comparison shows that the values differ. This prevents attempts to crack the encryption by feeding arbitrary data into the decryption core.

From another aspect, this invention provides a decryption core that comprises an RSA decryption stage that evaluates an expression of the form mᵢ=cᵢ^{y}mod(N) where y=is a low-valued exponent (for example, a value of 3) as part of the RSA decryption method. Preferably, the core makes use of one or more registers that perform different functions during calculation of the algorithm, so making efficient use of hardware within the core.

From yet a further aspect, the invention provides a media player comprising a store for storage of an encrypted file in which content is encoded, a decryption core and a media player core, in which the decryption core is configured with decryption parameters specific to an individual media player, the decryption core being operative to decrypt only such files as have been encrypted with compatible encryption parameters.

Advantageously, the decryption core and the media player core may have a monolithic construction whereby the unencrypted digital content is not present other than within the monolith. This can present a considerable obstacle to any attempt to extract the unencrypted digital signal from the player.

Several features of construction can be adopted to minimise the complexity and area of the core. For example, the core may evaluate the exponentiation part of the expression by serial addition. The core may evaluate the expression in a plurality of serial registers. To further reduce the complexity and area, at least one of the registers may hold different values during different stages of the process of evaluating the expression.

An embodiment of the invention will now be described in detail, by way of example, with reference to the accompanying drawings, in which:

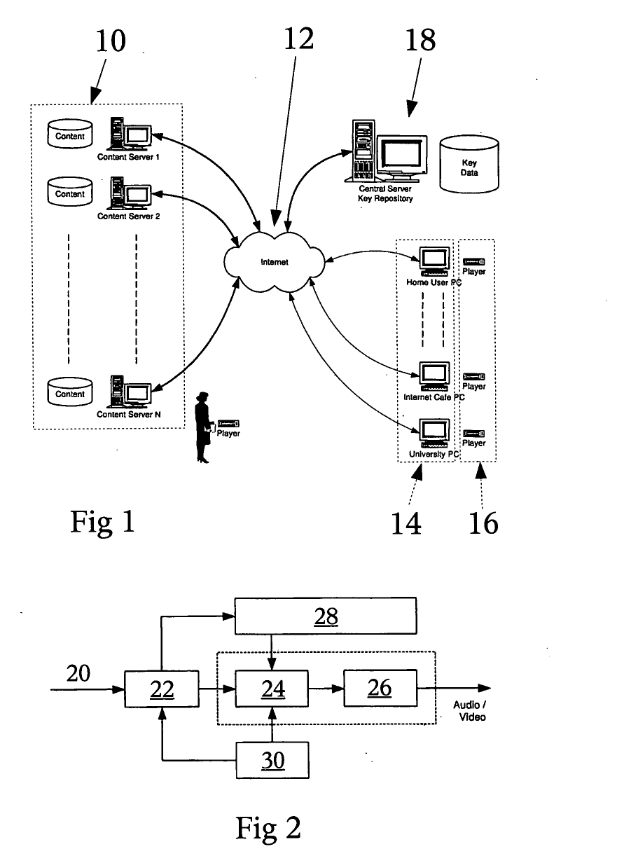

FIG. 1 is an overview of a content distribution system being a first embodiment of the invention;

FIG. 2 is a simplified block diagram of a player for use in the content distribution system of FIG. 1;

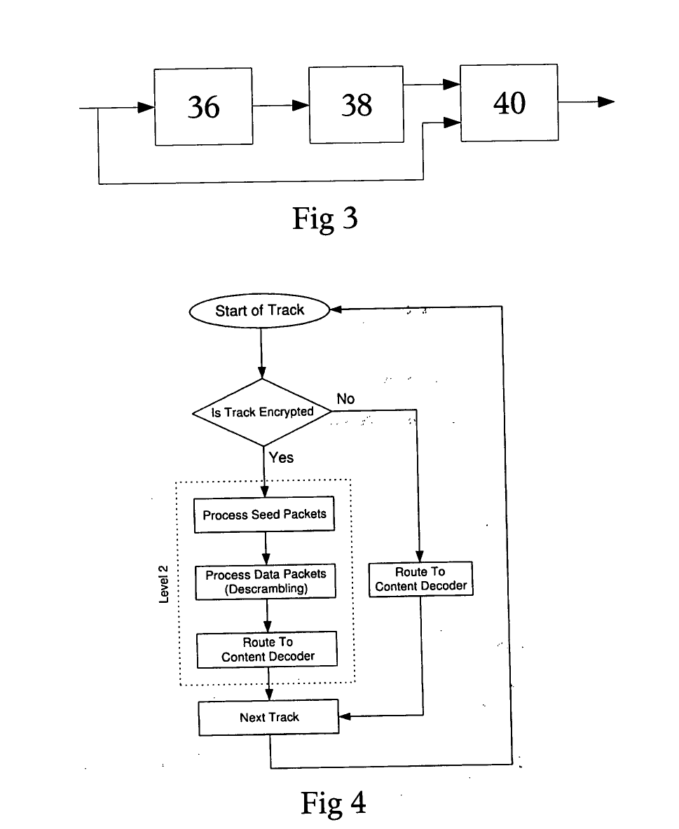

FIG. 3 is a simplified block diagram of a decryption core being a component of the player of FIG. 2;

FIG. 4 is a flowchart illustrating the steps performed by a media player in playing a track;

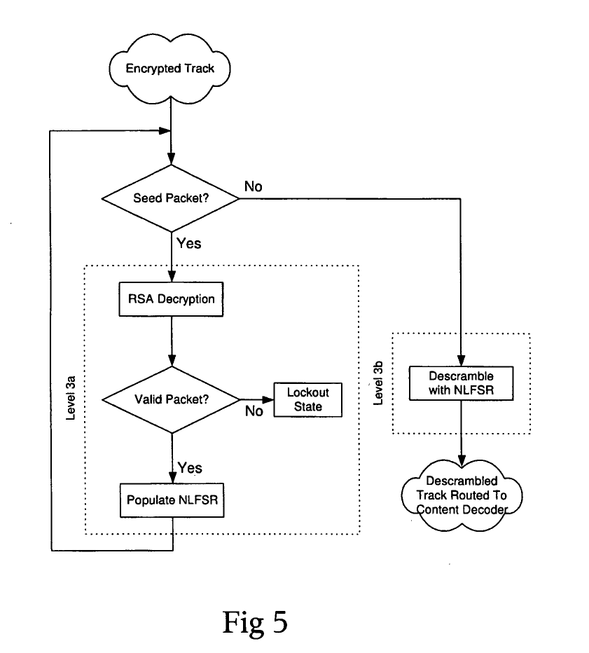

FIG. 5 is a flowchart illustrating in overview the steps performed by a media player in descrambling and decrypting content, corresponding to the block labelled “Level 2” in FIG. 4;

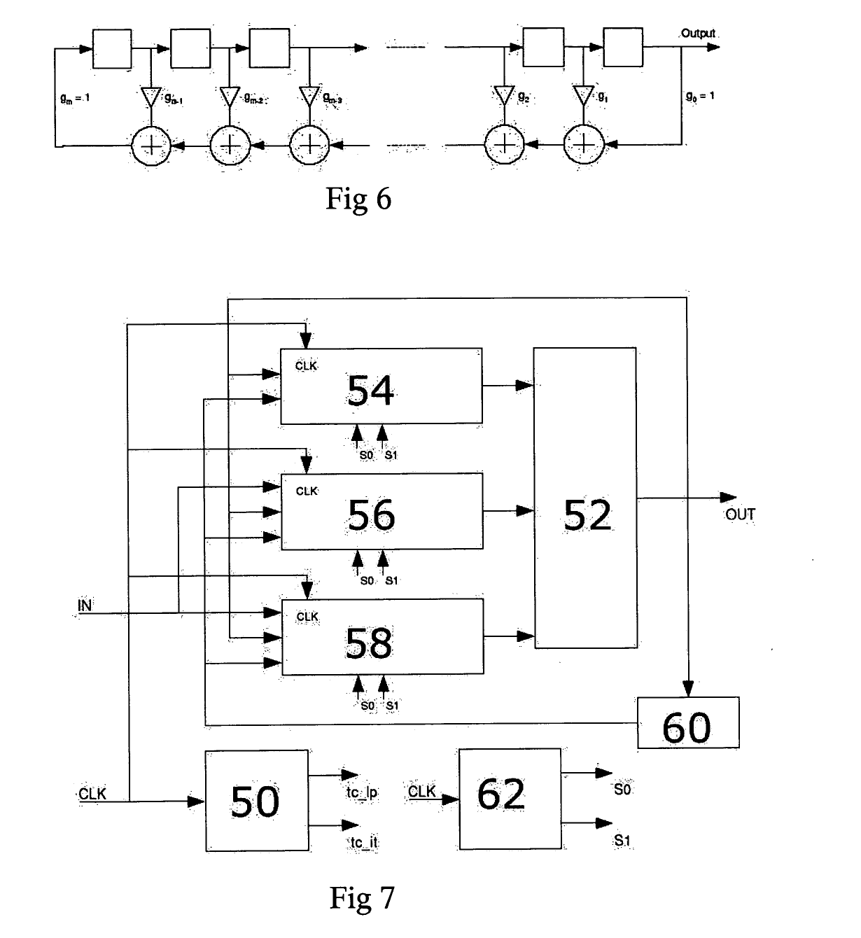

FIG. 6 is a diagram of the structure of a linear feedback shift register (LFSR);

FIG. 7 shows the principal components of an RSA core, being a part of the player of FIG. 2;

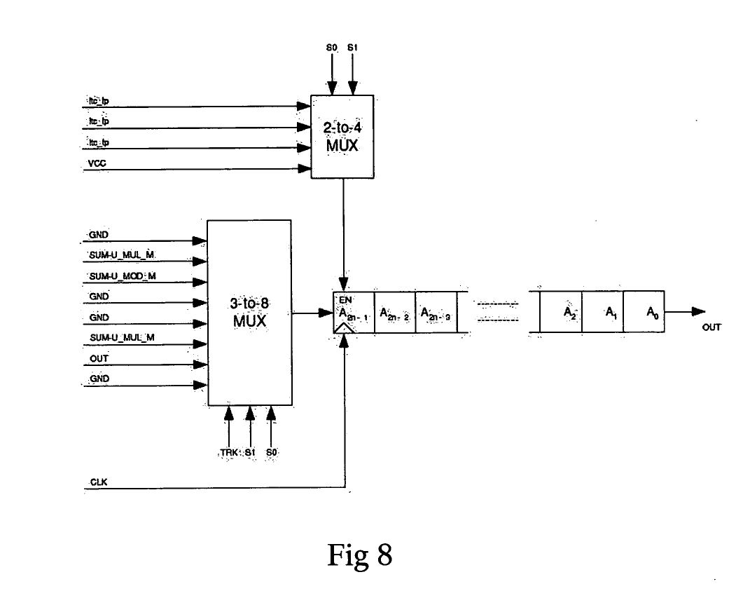

FIG. 8 shows the internal structure of a result register being a component of the RSA core of FIG. 7;

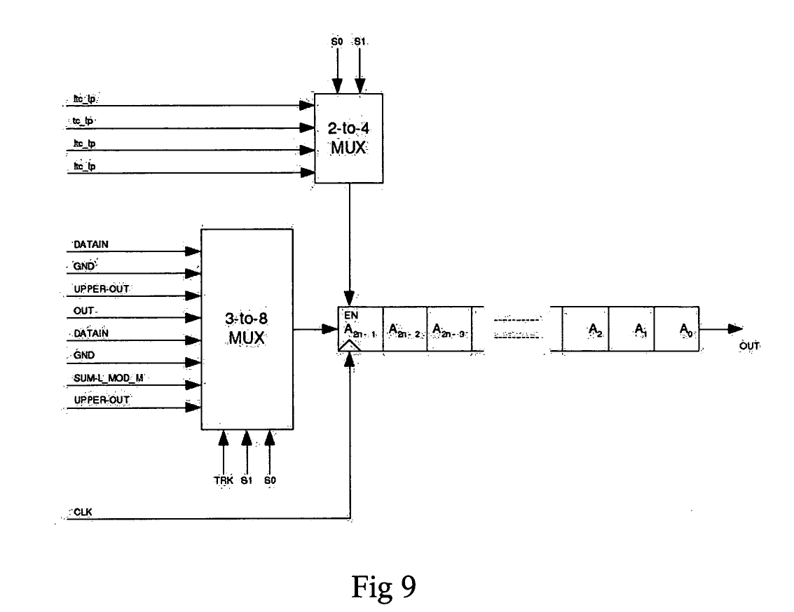

FIG. 9 shows the internal structure of a second result register being a component of the RSA core of FIG. 7;

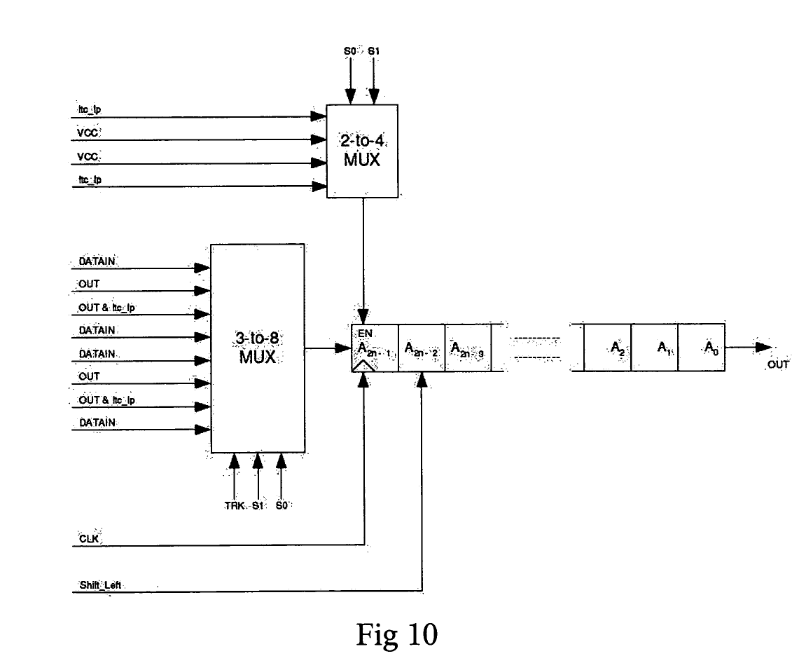

FIG. 10 shows the internal structure of a third register being a component of the RSA core of FIG. 7;

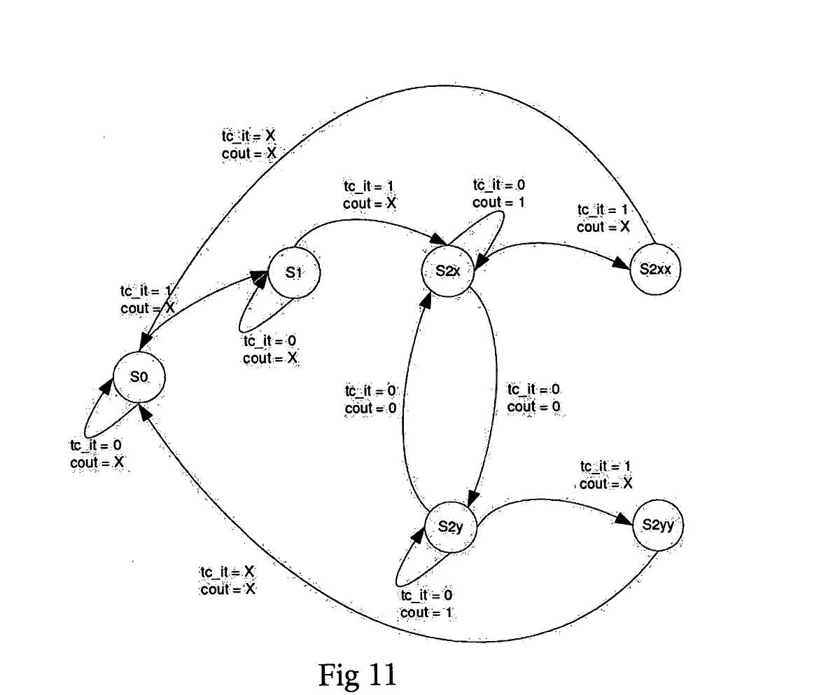

FIG. 11 is a state machine diagram of a tracker state machine being a component of the RSA core of FIG. 7;

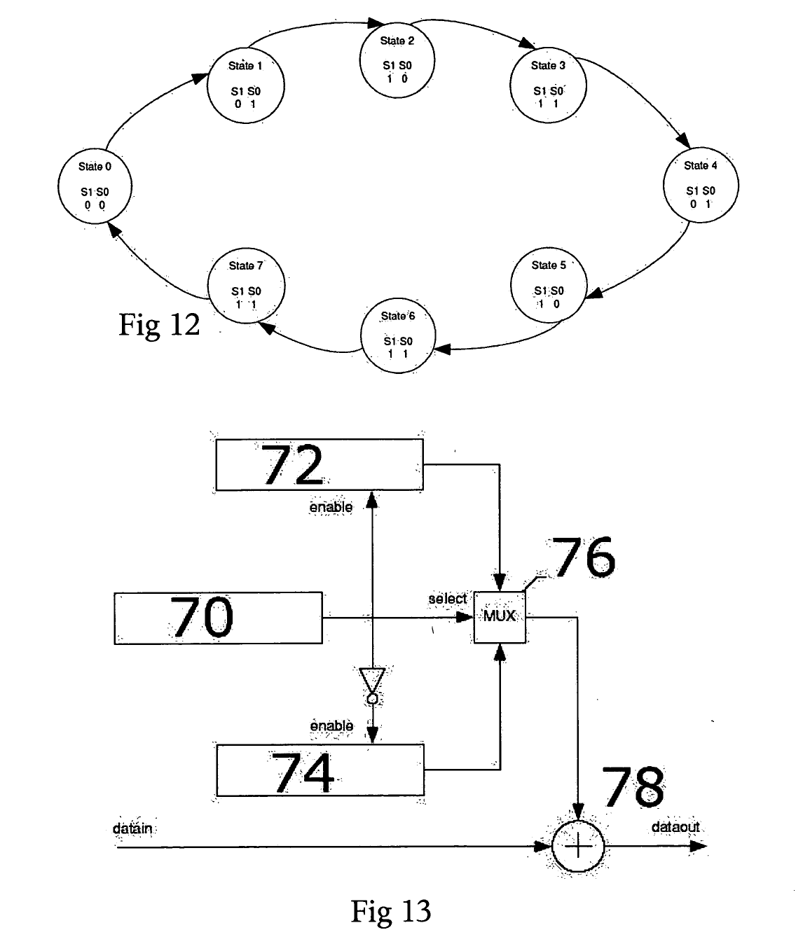

FIG. 12 is a state machine diagram of a multiplexer control state machine being a component of the RSA core of FIG. 7; and

FIG. 13 is a diagram of the structure of a non-linear feedback shift register (NLFSR).

This embodiment is a system for distributing audio content to users for playing on portable media players. The audio content is distributed in encrypted form in files that can be downloaded from an Internet web site on payment of an appropriate fee. The aim of the system is to allow any single file to be usable only upon one specific media player or on a specific group of media players.

Content is stored on one or more content servers 10. From there, it is distributed over the Internet 12 to users' computers 14, each content item being stored as a file on the computer 14. Prior to its transfer to the users' computers, the content is encrypted for use on a particular individual player 16 associated with a registered user of the system, the content server 10 receiving parameters for encryption for that user's player from a key server 18. The user can then copy the encrypted file onto their player 16, whereupon the player can be used autonomously of the computer 14. The player 16 is then capable of decrypting the file in real time to produce an output constituting an audio signal encoded according to a suitable standard audio encoding scheme, which can then be reproduced as an audio signal. The user can be encouraged to make backup copies of the downloaded file in the interest of security against loss. There is no point in the user distributing the files to others, because only the user's individual player can decrypt them.

The main component groups of a player for use with the system are shown in FIG. 2. The aim of the player is to take as an input an encoded file and generate as an output an analogue audio signal that reproduces the content encoded within the file. However, the player is designed so as to minimise the likelihood that access can be obtained to the decrypted data in digital form.

The player comprises a port connection 20, an interface device 22, a decryption core 24, a media player core 26, a non-volatile storage module 28 and a control module 30. The function of each of these will now be described.

The port connection 20 is a physical connection to a multitude of potential interfaces into which the encryption enabled media content player device might be connected. In this embodiment, the port connection 20 is constituted by a USB interface so that it can be connected to a wide range of computers, although many other types of interface may be used, and it is likely that higher-speed interfaces will be adopted in future embodiments. The port connection is connected 20 and delivers the encrypted data to the associated interface device 22.

The interface device 22 interfaces with the physical port connection 20 of choice, and reconciles both the electrical and protocol requirements associated with the interface. The interface device 22 is connected to, and delivers encrypted data to the decryption core 24.

The decryption core 24 accepts encrypted data that has been streamed through the interface device 22 and delivers unencrypted data at its output. The output of the decryption core is that of the streamed digital media content. It should be noted that the decryption core of each individual player has a unique decryption key, or at least a key that is selected from such a large pool of possible keys that duplication of a key is unlikely.

The media player core 26 accepts unencrypted streamed digital media content, typically in a compressed format such as the Motion Picture Experts Group MP3 format, and decompresses and reconstitutes media content into an analogue signal for amplification and reproduction internally or externally of the player.

Non-volatile data storage 28 allows for digital media content to be stored upon the device in encrypted form. A user can play content without having to have the media player device connected to the source of the original digital media content. The non-volatile data storage module can be constituted by non-volatile RAM memory (of which there are many suitable types already in existence and in development) or, where a larger storage capacity is required, a magnetic or optical disc.

The control module 30 is a logical controller that governs the overall operation of the digital media player device, including the routing of streamed data, and so forth.

One specific design feature that is intended to achieve reduce the possibility that unencrypted digital data can be extracted from the player is that the decryption core 24 and the media player core 26 have a monolithic construction. The unencrypted digital signal therefore exists only within the monolith, from where it cannot readily be extracted.

Having presented an outline of the principal components of the system, an overview of its operation will now be presented.

First, during manufacture, each player is assigned a unique serial number, and this is stored on the key server 18 together with the key that has been implemented in the decryption core of that player. When a user acquires a player, a user account is created on the key server 18 that associates a user identity with the serial number of the user's player. (This process of making the players unique may alternatively take place during a one-time programming configuration. This may be particularly applicable to players that are implemented using an EPLD or a FPGA-SPROM hybrid.)

In order to obtain content, a user uses a conventional computer 14 to contact a content server 10. Using a web interface to the content server 10, the user first logs into the content server, identifying himself or herself with the user identity they received when the account is created. The user selects an item of content and pays for it using conventional e-commerce techniques.

The content server then generates a random content seed and uses it to initialise an encryption module encrypt the content file. The seed must be transmitted to the player to enable it to decrypt the content. However, it cannot be sent in plaintext because it could then be used to decrypt the content. Therefore, the content server 10 contacts the key server 16 and requests the player key assigned to the user's player. The content server then uses this player key to encrypt the seed. The encrypted seed is added to the encrypted content and both are sent to the user to be stored as a file on their computer 14. At this stage, the file cannot be played because the user cannot decrypt it.

The user can then connect their player 16 to the computer 14 and copy the file to the player 16, where it is stored in the non-volatile storage module 28. When the user wishes to play the content, a procedure illustrated in FIG. 4 is followed. The control module 30 first analyses the track to determine whether or not the track is encrypted. If the track is not encrypted, it can be passed directly to the media player core 26. If it is encrypted, the control module 30 reads the file from the non-volatile storage module 28 and passes it to the decryption core 24. The decryption core decrypts the seed information contained in the file and then uses that seed to initialise a decryption module to decrypt the content itself. Content is decrypted on the fly and passed to the media player core 26 for reproduction.

The core architecture is realised using basic logic elements, which lends itself quite readily to instantiation within a programmable logic device such as an EPLD or FPGA. The core can be thought of as manifesting itself in three distinct, but tightly coupled decryption block elements 36, 38, 40. The first of the decryption block elements 36 is a linear feedback shift register (LFSR) core. The second of the decryption block elements 38 is a dedicated RSA decryption core. The third element 40 of the decryption block is a non-linear feedback shift register (NLFSR) core. A pictorial representation of the architecture is presented in FIG. 3.

The function of the LFSR core 36 is to strengthen the security of the RSA decryption core 38 that follows it, by allowing for the data streamed into the decryption core 26 to be scrambled. The function of the RSA core 38 is to protect register seed information for the NLFSR core 40 that follows it. The NLFSR core 40 is charged with the decryption of the actual streamed multi-media content.

Put simply, the function of the NLFSR is to generate a stream of pseudo-random bits which, when combined with the encrypted content in an exclusive-or operation, results in recovery of the unencrypted content. (Given the symmetrical nature of the exclusive- or operation, this is also the operation undertaken to encrypt the content.) Ideally, the NLFSR should be able to produce such a stream of bits in a sequence that does not repeat during the entire length of the content, although in practice this may not be achievable in all cases. The particular sequence of bits that is generated by the NLFSR is determined by a seed value stored in its registers. The seed is contained in an encrypted form within the file. Thus, to play an encrypted file, the first task that the player must undertake is to extract the seed value from the file. In this embodiment, the seed comprises three values, transmitted in six seed packets, each of which populates a respective one of the registers of the NLFSR.

As shown in FIG. 5, the first part of the encrypted file contains several seed packets. These are descrambled by the LFSR 36, decrypted by the RSA core 38 and then checked by the control module for consistency. If the consistency checks are passed, the packet is used to populate the registers of the NLFSR 38. If the consistency checks fail, the control module 30 causes the player 16 to enter a locked state, and can only be re-activated by powering it off and on again. Once the seed packets have been processed, subsequent packets are assumed to be encrypted data packets, and passed to the NLFSR 40 for decryption.

Components of the decryption core will now be described in further detail.

LFSR scrambling/descrambling is a technique which produces a pseudo random bit re-ordering of a data set. A pictorial representation of a LFSR architecture is shown in FIG. 6. The nature of the architecture is that of a series of delay elements (typically D-type flip-flops), arranged as a standard shift register. A series of binary-weighted taps are taken, summed together in modulo-2 fashion, and then fed back to form the input to the LFSR block. Each of the tap positions is assigned a weight gᵢ being either a ‘0’ or a ‘1’. A 0 value denotes that no connection is implemented, whereas a 1 denotes that a connection is present. A LFSR can be represented as a polynomial in x, of the form,
G(x)=gₘx^{m}+gₘ₋₁x^{m-1}+gₘ₋₂x^{m-2}+ . . . +g₂x²+g₂x²+g₁x+g₀ (1)

The generator polynomial can be used to determine the nature of the data sequence. A generator polynomial is said to be primitive if it cannot be factored, i.e. it is considered prime, and also if it is a factor of x^{N}+1, where N=2^{m}−1, (where m is the number of delay stages within the LFSR). A LFSR that is represented by what is considered as a primitive generator polynomial will produce a maximal length sequence, that is, one which exhausts all different register combinations before it repeats itself. Algorithms exist, and can be readily employed towards drawing inference from the output sequence of a LFSR. The process is such that the binary weighting values can be obtained once a sequence of twice the length of the shift register has been output from the LFSR, and hence the generator polynomial can be inferred. Once the generator polynomial has been obtained, an intruder can crack the encryption process and derive the plain text from the cyphertext. Therefore, unless it is possible to implement a pronouncedly long shift register length implementations, by itself the LFSR technique of scrambling is not very secure. Therefore, in the context of this embodiment it is just one part of the total encryption process.

One important aspect of the implementation of the decryption core 26 lies in the implementation of the RSA core 38. The non-linear mathematical nature of RSA encryption and decryption makes it computationally expensive to implement, especially in the context of realising a hardware instance of the algorithm. The two primary operations associated with the algorithm are that of a exponentiation or powering stage, and a mod( ) stage, i.e. of the form
x^{y}mod(z) (2)

Both of these mathematical operations are highly non-linear in the nature of their mapping of an input data set to an associated output data set. This more often than not makes them very difficult to realise efficiently in hardware.

RSA is primarily what is termed a public key encryption standard, in that one of the keys involved in both the encryption and decryption process are disclosed to all users. The other remaining keys involved in the process are kept private. RSA employs the highly non-linear behaviour of the mathematical mod( ) function in the translation process from plain text to cyphertext during the encryption process, and then from cyphertext back into plain text during decryption process. However, in embodiments of this invention, the key that would typically correspond to the public key—the key used for encryption—is withheld from the user. It is maintained on the key server. The decryption key is incorporated into the hardware of the player. Therefore, the authentication stage that would normally precede key exchange in a conventional method for transmitting data is rendered redundant.

The process for RSA encryption and decryption initially involves the selection of appropriately sized prime numbers, p and q. In general, the larger the prime numbers chosen, the more cryptographically secure the encryption process is, and it is also preferable that they be of nearly equal lengths. The prime numbers p, q are formed into a product to create N, i.e. N=p.q

The encryption strength of the algorithm is predicated upon the level of difficulty associated with the mathematical factorisation of the value N. A value for the encryption key e is then chosen, such that the value e, and the value φ are relatively prime (in other words, they have no common factors other than 1), where φ is given by:
φ=(p=−1)·(q−1). (3)

A value for the decryption value d is then computed such that
d=e⁻¹mod(φ). (4)

The RSA encryption process involves fragmenting a message into a number of numerical blocks. To encrypt a message m, first divide it into numerical blocks less than N (with binary data, choose the largest power-of-two less than N). The encryption of each of the message blocks mᵢ involves raising the message block mᵢ to the power of e, and then computing the mod(N) of the result. Allowing the encrypted message block mᵢ^{e} to be represented by cᵢ, we can write,
cᵢ=mᵢ^{e}mod(N). (5)

The resulting ciphertext blocks cᵢ are of the same length as that of the original message block mᵢ. The subsequent decryption of a ciphertext block then involves taking in turn each of the ciphertext blocks cᵢ, raising them to the power of d, and then computing the mod(N) of the result, i.e.,
mᵢ=cᵢ^{d}mod(N). (6)

The non-linear mathematical nature of RSA encryption and decryption makes it computationally expensive to implement, especially in the context of realising a hardware instance of the algorithm. As has been shown, the two primary operations associated with the algorithm are that of exponentiation, and mod( ) stage, i.e. of the form
x^{y}mod(z). (7)

Both of these mathematical operations are highly non-linear in the nature of their mapping of an input data set to an associated output data set. This makes them difficult to realise efficiently in hardware. However, both of these mathematical operations can be achieved using more primitive and fundamental mathematical operations. The powering operation can be realised using a series of multiplications cascaded together, and computed in sequence, while accumulating an interim result per multiplication to serve as an operand during the next multiplication. However, multiplication is itself a computationally expensive process, and this expense is accentuated in the context of exponentiation within the RSA algorithm. The robustness of the RSA algorithm, in terms of its security is largely predicated upon the pronounced difficulty associated with the factorisation of very large prime numbers. Therefore, the register precision lengths typically associated with the RSA algorithm tend to negate the use of some of the multiplication techniques to realise exponentiation.

In this embodiment, the exponentiation stage of the RSA algorithm is realised using serial addition. This is coupled with careful selection of the decryption key d adopted in the decryption process. Specifically, if serial operations are to be employed in the decryption process, a low valued exponent is required in practice.

It is known that multiple users of the same cryptography system may avail of the same choice of encryption key e, provided that the values for p and q are different. For optimum speed of processing, encryption keys should be chosen with the minimum number of bit elements set to 1 within the binary representation of the encryption key value. Such a candidate is that of the value of 3. Therefore, the decryption process described in equation becomes
mᵢ=cᵢ³mod(N). (8)

While this design decision is meets the theoretical requirements of the RSA algorithm, it also has the potential to allow for a highly efficient hardware realisation of the algorithm in terms of both resource consumption and execution time. However, cryptographically it is quite weak. Algorithms are available and can be readily employed which can expose low index exponentiation, and hence, expose the RSA parameters such that an intruder can crack the encryption process and derive the plain text from the cyphertext. One of the strengths of pursuing such an approach for the exponentiation stage of the RSA algorithmic process is that, through appropriate multiplexing and some augmentation, the exponentiation stage can be adapted to realise the mod(N) stage through an in-place successive approximation operation.

This embodiment implements a particularly efficient implementation of the mathematical operation associated the specific RSA decryption process represented by equation 8. It has been established also that a more optimised, and hence more hardware resource efficient, architecture would present itself if equation 8 were carried out in four mathematical staged operations as opposed to the two staged operations suggested by first inspection of equation 8. For two-stage operation, an arbitrary precision register length n, the resulting register would require a precision length of 3n, and all of the subsequent sub-additions and sub-subtractions associated with the decryption would have to be carried out as a 3n-order sub-process within the algorithm. However, by realising the equation in four stages, the precision length of the computation is of order 2n, and all of the subsequent sub-additions and sub-subtractions could be carried out as a 2n order sub-process within the algorithm. The four mathematical staged operations are: a multiplication followed by the mod(N) stage, followed by a multiplication followed by the mod(N) stage. This can be represented mathematically as shown in equation 9.
mᵢ=((cᵢ·cᵢmod(N))·cᵢ)mod(N) (9)

Consider the steps involved in carrying out the computation detailed in equation 9
1. Compute the product cᵢ·cᵢ.
2. Compute mod(N), by employing the result emanating from step 1 as an argument to the mod(N) operation.
3. Compute the product of cᵢ and the result emanating from step 2.
4. Compute the mod(N), by employing the result emanating from step 3 as an argument to the mod(N) operation.

The architectural blocks associated with this process then are essentially a binary multiplier and a binary mod(N) stage. For efficiency in its consumption of resources, in this embodiment, these stages are realised in a serial fashion. Therefore, the primary component module block elements associated with the RSA core unit are serial block elements.

The primary component module block elements associated with the RSA core are:
a timing unit 50;
an arithmetic logic unit 52;
a upper result register 54;
a lower result register 56;
a mult/mod register 58;
a tracker state machine 60; and
a multiplexer control state machine 62.

A pictorial representation of the RSA decryption core architecture is presented in FIG. 7.

The timing unit 50 is responsible for generating two tightly coupled pulses which by and large govern phased addition and subtraction operations of the primary core in carrying out the RSA decryption process, presented earlier in equation 9. The inputs of the timing unit are:
clock—the global clock input;
reset—the timing unit reset input which puts the unit into a known starting state from which all other timing activity is derived; and
pen—the 2nd LSB of the lower result register 56, or penultimate bit, which is used to advance the iteration count by one should the value of the input be equal to a logic zero which would indicate a multiplication by binary zero.

The outputs associated with the timing unit 50 are:
tc_lp—the loop counter terminal count pulse; and
tc_it—the iteration counter terminal count pulse.

The primary internal blocks of the timing unit module are:
a loop counter; and
an iteration state machine based counter.

The loop counter has a modulus of 2n, where n is the register precision length, and produces a terminal count pulse on tc_lp, which is asserted for one clock pulse when the terminal count is reached. The loop counter is a free-running counter that runs continuously. The iteration state machine based counter is a state machine that has a dynamic modulus, depending upon the particular phase of the RSA decryption operation under consideration. The moduli are n and n+1, and produces a terminal count pulse on tc_it. However, the assertion of the terminal count pulse can be 1, 2 or 3, again depending upon the particular phase of the RSA decryption operation under consideration. This facilitates the migration of the current process to another phase of the algorithm, which may involve the moving of operands, etc. Also, since both terminal count pulses largely govern the advancement of the algorithm through the required phases, having a non-standard terminal count value associated with one of the pulses allows for a more time efficient propagation through the algorithm.

The arithmetic logic unit (ALU) 52 is the block element that is responsible for all of the serial mathematical computation associated with the RSA decryption process. The ALU 52 has three binary single-bit full adders within it, one configured as an adder and two configured as subtractors. The ALU is also furnished with three single-bit D-Type flip-flop-based sequential elements. These hold the generated carry-out terms, to serve as a carry-in input term for the next calculation. The inputs of the ALU 52 are:

clock—the global clock input;

tc_lp—the loop counter terminal count pulse from the timing unit 50;
u—the serial output of the upper result register 54;
l—the serial output of the lower result register 56; and
m—the serial output of the mult/mod register 58.

The outputs associated with the ALU 52 are:
sum-u_mul_m—the sum term associated with u+m during the multiplication/summation phase of the RSA process;
cout-u_mul_m—the carry out term associated with u+m during the multiplication/summation phase of the RSA process;
sum-u_mod_m—the sum term associated with u−m during the mod(N)/difference phase of the RSA process;
cout-u_mod_m—the carry-out term associated with u−m during the mod(N)/difference phase of the RSA process.
sum-u_mod_l—the sum term associated with u−l during the mod(N)/difference phase of the RSA process.
cout-u_mod_l—the carry-out term associated with u−l during the mod(N)/difference phase of the RSA process.

Irrespective of the operation that is taking place at any given time, results are presented on each of the outputs of the ALU block element. Therefore, the core must route the result pertinent to the particular operation under consideration at a particular time. This is part of optimising the speed performance of the ALU.

The upper result register 54 is primarily a shift register, which shifts logically to the right (from MSB towards LSB). However, as a component module block element, it may be thought of as a shift register which is preceded by a single-bit multiplexer and a state machine which drives the select lines of the single-bit multiplexer. The architecture of the upper result register 54 is depicted in FIG. 8.

The inputs associated with the upper result register 54 are:
clock—the global clock input;
tc_lp—the loop counter terminal count pulse from the timing unit 50;
sum-u_mul_m—the serial output of the ALU 48 which delivers the sum of u, the output from the upper result register 54 and m, the output of the mult/mod register 58;
sum-u_mul_m—the serial output of the ALU 48 which delivers the difference of u, the output from the upper result register 54 and m, the output of the mult/mod register 58;
TRK—the output of the tracker state machine 60;
S0—the LSB output of the multiplexer control state machine 62; and
S1—the MSB output of the multiplexer control state machine 62.

The output of the upper result register 54 is
out—the serial output of the Upper Result Register module.

The multiplexer control state machine 62 governs how the upper result register 54 manifests itself within the algorithm. The multiplexer control state machine 62 selects which of the potential inputs is fed into the register and how the register is enabled for that particular phase. As the multiplexer control state machine 62 advances through its states, the upper result register 54 adopts a multitude of roles, thus implementing register re-use and consequently reducing hardware complexity. This facilitates an in-place computation of the algorithm, that is to say, the same register elements are used for both eponentiation and mod(N) allowing for greater hardware efficiency.

The lower result register 56 is primarily a shift register, which shifts logically to the right (from MSB towards LSB). However, as a component module block element, it may be considered as a shift register which is preceded by a single-bit multiplexer and a state machine which drives the select lines of the single-bit multiplexer. The architecture of the upper result register 56 is depicted in FIG. 9.

The inputs of the lower result register 56 are:
clock—the global clock input;
tc_lp—the loop counter terminal count pulse from the timing unit 50;
sum-l_mod_m—the serial output of the ALU 52 which delivers the sum of u, the output from the upper result register 54 and m, the output of the mult/mod register 58;
datain—the encrypted cyphertext input to the decryption core;
upper-out—the serial output of the upper result register 54;
out—the serial output of the lower result register 56;
S0—the LSB output of the multiplexer control state machine 62; and
S1—the MSB output of the multiplexer control state machine 62.

The output of the lower result register 56 is:
out—the serial output of the lower result register 56.

The multiplexer control state machine 62 governs how the lower result register 56 operates within the algorithm. The multiplexer control state machine 62 selects which of the potential inputs is fed into the register, and how the register is enabled for that particular phase. As the multiplexer control state machine 62 advances through its states, the lower result register 56 serves several different functions with benefits that have already been discussed.

The mult/mod register 58 is primarily a shift register, which (unlike its upper and lower result register counterparts described above) must possess the capacity to logically shift both to the right and to the left. This register is a dual-purpose register. It holds the operand that is successively scaled by 2 during the interim product stage of the multiplication process. It also serves as the modulo register associated with the successive approximation division process (that is, where no quotient term is generated and the remainder is most pertinent). While the shift register must have the capacity to logically shift both to the right and to the left, the majority of the operations associated with this register involve shifting to the right, from the MSB towards the LSB. As a component module block element, however, it is a shift register that is preceded by a single bit multiplexer and a state machine that drives the select lines of the single bit multiplexer. The architecture of the mult/mod register 58 is depicted in FIG. 10.

The inputs of the mult/mod register module 58 are:
clock—the global clock input;
tc_lp—the loop counter terminal count pulse from the timing unit 50;
datain—the encrypted cyphertext input to the decryption core;
out—the serial output of the mult/mod Register module.
S0—the LSB output of the multiplexer control state machine 62; and
S1—the MSB output of the multiplexer control state machine 62.
Shift Left—the control signal which shifts the contents of the shift register to the left as opposed to the right upon it s assertion.

The output of the mult/mod register 58 is:
out—the serial output of the mult/mod register 58.

As before, the multiplexer control state machine 62 governs how the mult/mod register 58 manifests itself within the algorithm. The multiplexer control state machine 62 governs which of the potential inputs is fed into the register, and how the register is enabled for that particular phase. As the multiplexer control state machine 62 advances through it s states, the mult/mod register 58 can adopt several roles towards register re-use.

The a tracker state machine 60 is a state machine which is based upon the Moore state machine model, which has no output-forming logic employed such that the output is non-combinatorial, or is considered as being a registered output. The progression of the tracker state machine 60 is detailed in the state machine state diagram presented in FIG. 11.

The inputs of the tracker state machine 60 are:
clock—the global clock input;
reset—The timing unit reset input which puts the unit into a known starting state from which all other timing activity is derived; and
tc_lp—the loop counter terminal count pulse from the timing unit 50;
tc_it—the iteration state machine based counter terminal count pulse; and
cout—the carry-out output the ALU 52.

The output of with the tracker state machine 60 is:
track—the tracking output of the tracker state machine 60.

The primary function of the tracker state machine 60 is to facilitate the storage of the operand during the successive approximation based subtractions during the mod(N) stage of the RSA decryption process. It achieves this by driving one of the multiplexer select inputs, which switches the role of the three computation registers 54, 56, 58 described above, so changing the routing of the data within the architecture, and hence, the algorithmic progress of the RSA decryption process. During the mod(N) stages of the RSA decryption process not involving mod(N), the output of the Tracker State Machine module is forced into a known state where is it largely dormant.

The multiplexer control state machine 62 is a state machine also based upon the Moore state machine model. As mentioned earlier, the multiplexer control state machine 62 governs how the three computation registers 54, 56, 58 function during a particular computational phase of the RSA decryption process. The state machine progression is detailed in the state machine state diagram, which is depicted in FIG. 12.

The inputs of the multiplexer control state machine 62 are:
clock—the global clock input;
reset—the timing unit reset input which puts the unit into a known starting state from which all other timing activity is derived;
tc_lp—the loop counter terminal count pulse; and
tc_it—the iteration state machine based counter terminal count pulse.

The outputs of the multiplexer control state machine 62 are:
S0—the LSB output of the Multiplexer Control State Machine module; and
S1—The MSB output of the Multiplexer Control State Machine module

The multiplexer control state machine 62 changes state when both of the terminal count pulses, i.e. tc_lp and tc_it are both asserted, indicating the end of a computation phase, and hence, initiating a new computation phase of the RSA decryption process.

The manner in which the RSA decryption process is performed by the hardware discussed above will now be described.

The RSA decryption process involves configuring the multiplexer state machines to drive the select lines of the multiplexer in the correct sequence such that the operations detailed in above and represented by equation 9 are carried out in the correct order. There are eight stages associated with this RSA decryption process. Not all of the stages are strictly computational phases of the RSA decryption process. The non-computational stages primarily serve to re-position data, or to preset certain registers in order to employ numeric values embedded within the device. The eight phases associated with the process are will now be described.

Phase S0—In this phase, data is loaded into the lower result register 56 and the mult/mod register 58. The inverse LFSE transform has taken place and it is the resulting data that is fed into the lower result register and the mult/mod register. During this phase, no computation takes place and the upper result register 54 is disabled.

Phase S1—In this phase, a multiplication is carried out by repeatedly accumulating the value in the mult/mod register 58, which is scaled by 2 upon receipt of each assertion of the tc_lp terminal count pulse, into the upper result register 54. Each partial product accumulation is predicated upon the logic level of the current LSB of the lower result register 56, which is repeatedly shifted to the right upon receipt of each assertion of the tc_lp terminal count pulse and acts as a qualifier which dictates whether or not the partial product accumulation should take place.

Phase S2—In this phase, a successive approximation series of subtractions are carried out. As Phase 1 ends, the value N is loaded into the mult/mod register 58 and is repeatedly subtracted from either the upper result register 54 or the lower result register 56, depending upon how the data is routed. This is stipulated by the output of the tracker state machine 60, which interprets the cout value from the previous arithmetic operation. At the end of this phase, the result of Step 2 of the four steps described above resides in either the upper result register 54 or the lower result register 56.

Phase S3—In this phase, result data is repositioned such that the operand data resides in the lower result register 56. Also, during this phase the upper result register 54 is flushed to arithmetic zero and the mult/mod register 58 is again loaded with the original cyphertext data (which is stored in the LFSR inverse transform register).

Phase S4—During this phase of the process a multiplication is carried out in the same fashion detailed in Phase S1.

Phase S5—During this phase, a successive approximation series of subtractions are carried out in the same fashion detailed in Phase S2.

Phase S6—In this phase, the result data is again repositioned such that the operand data resides in the lower result register 56. Also, during this phase the upper result register 54 is preset with a unique identification code that is embedded within the device in a manner in which it cannot readily be extracted from the device by a user.

Phase S7—During this phase, the lower order bits are serially flushed out of the lower result register 56 into the NLFSR 40, which follows it. During this process the upper order bits of this register, which holds a unique identification value within the downloaded encrypted data packet, is correlated with the preset unique identification value loaded into the upper result register 54 established in Phase S6. Should these values not match during this flushing process, the device is entered into a state which requires it to be rebooted, thus preventing erroneous attempts, such as soliciting information from the device by attacking it with packets which do not possess the unique identification field.

The structure of the NLFSR is shown in FIG. 13.

The NLFSR encryption/decryption technique, also termed an alternating stop and go generator, is a technique that realises a pseudo-random bit reordering of a data set in a highly non-linear fashion.

The NLFSR architecture can be constructed using a number of standard maximal length LFSR block elements configured as shown in FIG. 13. The nature of the architecture is that of three interconnected LFSR block elements 70, 72, 74. The LFSR block elements 70, 72, 74 have been configured, in terms of the binary weightings of their tap positions, for maximal length sequencing, and have been seeded accordingly with the decrypted seed.

One of the LFSR blocks 70 is configured, through its output, to drive the enable control signal of both of the other LFSR block 70, 72 in a mutually exclusive fashion. That is to say, while either one of the LFSR blocks is enabled, the other is disabled. In parallel with this operation, the same output is used to drive a select line of a 2-to-1 single-bit multiplexer element 76, and in so doing feeds the output of the active LFSR block into a modulo-2 multiplication element 78. The other input to this modulo-2 element 78 is an input data sequence of bits of the encrypted content. These bits are consequently multiplied by the multiplexed, and what is termed stop and go, sequence output.

While the NLFSR block element 40 is comprised of LFSR block elements 70, 72, 74, one might be forgiven for assuming that it is subject to the same deficiency outlined in LFSR encryption described above. However, because the upper and lower LFSR 72, 74 block element sequences are started and stopped, in a highly non-linear fashion, by the centre LFSR 70 block element, it is difficult to draw inference from the output sequence to deduce the binary weightings of the LFSR tap positions. Towards augmenting this difficulty, each of the LFSR block elements are chosen with differing lengths which are prime, and with binary weightings which are of maximal length. A consequence of this architecture is that the period of the output sequence has a large period. Therefore, provided that the tap positions are not disclosed, and provided that the seed values of the LFSR registers remain unknown, the NLFSR block elements 40 offers a pronouncedly high level of security.

The method for creating the encrypted media file is essentially the reverse of the decryption procedure. However, the encryption procedure is performed by server computers, so is typically performed by software components executing upon general-purpose computer hardware. The requirement to implement encryption algorithms in hardware does not arise. Therefore, the content sever 10 operates a software system that comprises modules that emulate the operation of the LFSR, the RSA core and the NLFSR. Construction of such software modules is a matter that is well within the skill of those working in the technical field.

The software selects at random a seed value for the NLFSR. The seed value is used to seed the NLFSR module, and its output is then combined with the content by an exclusive-OR operation. The resulting encrypted content is stored. The RSA module then subjects the seed values to RSA encryption with the RSA encryption key of the player for which it is intended. The LFSR module is then programmed to operate with a generator polynomial that corresponds to the position of the taps in the hardware LFSR in the player for which it is intended. The encryption key and the specification of the polynomial are both included within the encryption data that was downloaded from the key server 16.

The encrypted seed and the encrypted content are then stored in a file, with the encrypted seed at the start of the file. The file can then be sent to the requested computer.

1. A method of encrypting data set comprising:
generating a seed value;
seeding a pseudo-random number generator with the seed value;
creating an encrypted data set by combination of the output of the pseudo-random number generator with the data set; and
encrypting the seed value and associating the encrypted seed value with the encrypted data set.

2. A method according to claim 1 in which the combination operation is an exclusive-OR operation.

3. A method according to claim 1 in which the step of encrypting the seed value may include application of an RSA encryption algorithm.

4. A method according to claim 1 in which a transform is applied to the encrypted seed.

5. A method according to claim 4 in which the transform is applied by passing the data through a linear feedback shift register.

6. A method according to claim 5 in which the linear feedback shift register has a maximal length sequence.

7. A method according to claim 1 in which the pseudo-random number generator has a repeat period that is more than half the length of the data set to be encrypted.

8. A method according to claim 1 in which the pseudo-random number generator has a repeat period that is more than the length of the data set to be encrypted.

9. A method according to claim 1 in which the pseudo-random number generator incorporates a non-linear feedback shift register.

10. A method according to claim 1 in which the encrypted data set is stored in a file together with the encrypted seed value.

11. A method for decrypting an encrypted data set comprising
receiving an encrypted seed value associated with the encrypted data set;
decrypting the seed value and seeding a pseudo-random number generator with the seed value;
creating an unencrypted data set by combination of the output of the pseudo-random number generator with the encrypted data set.

12. A method according to claim 11 in which the combination operation is a exclusive-OR operation.

13. A method according to claim 12 in which decryption of the seed value includes application of an RSA decryption algorithm.

14. A method according to claim 11 in which a transform is applied to the encrypted seed.

15. A method according to claim 14 in which the transform is applied by passing the data through a linear feedback shift register.

16. A method according to claim 15 in which the linear feedback shift register has a maximal length sequence.

17. A method according to claim 11 in which the pseudo-random number generator has a repeat period that is more than half the length of the data set to be encrypted.

18. A method according to claim 11 in which the pseudo-random number generator has a repeat period that is more than the length of the data set to be encrypted.

19. A method according to claim 11 in which the pseudo-random number generator incorporates a non-linear feedback shift register.

20. A method according to claim 11 the encrypted seed value and encrypted data set are obtained from a common file.

21. A method according to claim 11 in which the encrypted data set is generated by a method according to claim 1.

22. A method of secure distribution of a data set from a server to a client in which the data set is encrypted by way of a method according to claim 1, transmitted the data over a network link, and decrypted by a method according to claim 21.

23. A method for distributing content from a content server for use by a pre-registered user, comprising: receiving a request from a user for an item of content; identifying the user; obtaining from a database encryption data corresponding to the identified user; encrypting the content using the encryption data; and transmitting the encrypted content to the user; in which the encryption data is associated with the user upon registration and is not subsequently communicated to the user.

24. A method for distributing content according to claim 23 in which the step of encrypting the content is in accordance with claim 1.

25. A method for distributing content according to claim 23 in which the step of encrypting the content is in accordance with claim 5 in which the encryption data includes a specification of the taps to be set on the LFSR during application of the transform.

26. A method for distributing content according to claim 23 in which the step of encrypting the content is in accordance with claim 3 in which the encryption data includes an RSA encryption key.

27. A method for distributing content according to claim 23 further comprising the step of loading the encrypted content into a content reproducing device, the device having been configured to decrypt data sets that have been encrypted by the encryption data.

28. A method for distributing content according to claim 27 further including the step of embedding in encrypted content a value that identifies the device by which it is intended to be reproduced.

29. A method for distributing content according to claim 28 further comprising comparing the value that identifies the device within the data set with a value that identifies the device into which the data has been loaded and causing operation of the device to be discontinued in the event that the comparison shows that the values differ.

30. A decryption core comprising an RSA decryption stage that evaluates an expression of the form mᵢ=cᵢ^{y}mod(N) where y=3 as part of the RSA decryption method.

31. A decryption core according to claim 30 in which in which the expression is computed in four steps:
1. compute the product cᵢ·cᵢ;
2. compute mod(N), by employing the result emanating from step 1 as an argument to the mod(N) operation;
3. compute the product of cᵢ and the result emanating from step 2; and
4. compute the mod(N), by employing the result emanating from step 3 as an argument to the mod(N) operation.

32. A decryption core according to claim 30 in which the core evaluates the exponentiation part of the expression by serial addition.

33. A decryption core according to claim 30 in which the core evaluates the expression in a plurality of serial registers.

34. A decryption core according to claim 33 in which at least one serial register holds different values during different stages of the process of evaluating the expression.

35. A media player comprising a store for storage of an encrypted file in which content is encoded, a decryption core and a media player core, in which the decryption core is configured with decryption parameters specific to an individual media player, the decryption core being operative to decrypt only such files as have been encrypted with compatible encryption parameters.

36. A media player according to claim 35 having an identification code that identifies an individual player, the player being operative to compare an identification code within the encrypted file with its own identification code, and in the event that the comparison identifies a difference in the identification codes, the player is operative to enter an inactive state.

37. A media player according to claim 36 which, having entered the inactive state, must be subject to a hardware reset before its function will be re-activated.

38. A media player according to claim 35 in which the decryption core extracts key information from the encrypted data set and uses the decryption data to extract unencrypted content from the encrypted data set.

39. A media player according to claim 35 in which the decryption core includes a decryption stage that implements a decryption algorithm in hardware registers.

40. A media player according to claim 39 in which the decryption core implements an RSA decryption algorithm.

41. A media player according to claim 40 in which the decryption core implements the RSA decryption algorithm by way of a core in accordance with claim 30.

42. A media player according to claim 40 in which the algorithm applied by the decryption core uses a decryption key that differs from one player to another.

43. A media player according to claim 42 in which the decryption key cannot readily be determined by a user.

44. A media player according to claim 30 in which the decryption code further includes a descrambler transform stage.

45. A media player according to claim 40 in which the descrambler transform stage is a linear feedback shift register (LFSR).

46. A media player according to claim 41 in which the LFSR has taps that differ from one player to another.

47. A media player according to claim 35 in which the encrypted data within the file is first transformed by the descrambler transform stage and then decrypted by the decryption stage.

48. A media player according to claim 35 in which the decryption core includes a pseudo-random number generator, the seed for which is derived from encrypted data within the data set.

49. A media player according to claim 48 in which the decryption core includes a pseudo-random number generator, the seed for which is derived from the output of the decryption stage.

50. A media player according to claim 48 in which the pseudo-random number generator is a non-linear feedback shift register (NLFSR).

51. A media player according to claim 50 in which the NLFSR includes a plurality of LFSR blocks, the output of the NLFSR being a stream of bits derived from the multiplexed outputs of two or more of the LFSR blocks.

52. A media player according to claim 51 in which the NLFSR includes a multiplexer to select one LFSR block as that which will provide the output, the multiplexer being controlled by an output of a further LFSR block.

53. A media player according to claim 52 in which each LFSR block has taps that differ from one player to another.
